(19) United States
(12) Patent Application Publication
(10) Pub. No.: US 2002/0176393 A1
(43) Pub. Date: Nov. 28, 2002

(54) Reduction in circuit scale of RAKE receiver in CDMA communication system

(76) Inventor: Yuichi Maruyama, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/107,173

(22) Filed: Mar. 28, 2002

(30) Foreign Application Priority Data
Apr. 6, 2001 (JP) 2001-108460

(51) Int. Cl. H04B 7/216

(52) U.S. Cl. 370/342; 370/441

(57) ABSTRACT

A RAKE receiver according to the present invention has a chip rate finger processing unit for despreading received data and performing symbol integration for the received data, and a symbol rate finger processing unit for estimating propagation paths through which the received data has passed, and compensating the received data for the propagation paths. The RAKE receiver further has a number of chip rate finger processing units corresponding to the number of fingers, and symbol rate finger processing unit for the plurality of chip rate finger processing units. The symbol rate finger processing unit compensates each of received data delivered from the plurality of chip rate finger processing units for an associated propagation path, and combines received data sharing a common multiplexed code with one another for each multiplexed code.

### BACKGROUND OF THE INVENTION

1. Field of the Invention

The present invention relates to a RAKE receiver for performing RAKE reception in a CDMA (Code Division Multiple Access) communication system, and more particularly, to a RAKE receiver which performs multi-code reception as well as the RAKE reception.

2. Description of the Related Art

Conventionally, a CDMA communication system employs a RAKE receiving method which utilizes a plurality of propagation paths (multi-path).

The RAKE receiving method refers to a receiving method for use in outdoor mobile communications, which receives radio waves that arrive after they are reflected or deflected by buildings such as skyscrapers and land features such as mountains, in addition to a radio wave directly arriving from a base station, and performs phase adjustments of the received radio waves, and the like. As mentioned, in the outdoor mobile communications, radio waves from a base station arrive through a plurality of propagation paths, where the number of propagation paths in this event is called the number of fingers.

Because of the above-mentioned strategy, the RAKE receiving method is capable of increasing the whole received power over a receiving method which only receives a directly arriving radio wave, and consequently providing stable reception.

Recently, with an increase in the amount of data, communications of multimedia information such as moving image data and the like are required to provide increasingly faster data communication rate. A typical method of increasing a data communication rate is a code multiplex method which permits a single user to use a plurality of codes to increase the data communication rate.

Laid-open Japanese Patent Application No. 2000-31938 discloses a receiver for CDMA communication which is provided with capabilities of both RAKE reception and code multiplex reception. This receiver is characterized by assigning different spread codes to correlators and detectors for the RAKE reception, and additionally using these correlators and detectors as correlators and detectors for the code multiplex reception. This receiver switches between the RAKE reception and code multiplex reception depending on whether it is used outdoors or indoors. For example, in indoor communications in which the RAKE reception is not available, the code multiplex reception is performed to provide high speed communications.

In the receiver disclosed in the aforementioned patent gazette, the code multiplex reception is performed on the assumption that the receiver is in a stationary state and in a surrounding environment is free of multipath. However, recently, a high transmission rate on the order of 384 kbit/second is required even in a moving state and in an environment in which multipath is present.

To meet this requirement, the aforementioned patent gazette discloses the configuration of a RAKE receiver, as a prior art, which comprises a plurality of conventional RAKE receiver circuits, and a multiplexer circuit for controlling these RAKE receiver circuits with respect to the multiplexing of codes. FIG. 1 illustrates the configuration of a conventional RAKE receiver which is provided with three fingers and permits a single user to use three multiplexed codes.

As illustrated in FIG. 1, this exemplary conventional RAKE receiver comprises A/D converter 100; three receiver units 101-103 provided for code 1-code 3 corresponding to the number of multiplexed codes; and multiplexer circuit 104.

A/D converter 100 converts an input received signal to a digital signal which is supplied to receiver units 101-103 as a received baseband digital signal.

Receiver units 101-103 each comprise three finger units 105-107, the number of which corresponds to the number of fingers, responsible for despreading of a received baseband digital signal from A/D converter 101, symbol integration, propagation path estimation and propagation path compensation; and a channel combiner 108 for RAKE combining output data from each of finger units 105-107 and outputting the resulting data.

Multiplexer circuit 104 multiplexes output data from receiver units 101-103 to deliver demodulated data.

While the aforementioned patent gazette does not present detailed description on the configuration of each finger unit 105-107, it is thought that the configuration is similar to that illustrated in FIG. 2.

The finger unit in this example of the prior art, as illustrated in FIG. 2, comprises spread code generator 111, pilot detectors (correlators) 112, 113, propagation path estimator 114, and propagation path compensator 115.

Spread code generator 111 comprises PN generators 111₁, 111₂ each for generating a PN (Pseudo-random Noise) code; and orthogonal code generator 111₃ for generating an orthogonal code. PN generators 111₁, 111₂ and orthogonal code generator 111₃ each operate based on control signals from a searcher unit (not shown).

Pilot detector 112 comprises despreaders 112₁, 112₂ for despreading the received baseband digital signal from A/D converter 100 using a PN code and an orthogonal code, respectively; and symbol integrator 112₃ for performing a symbol integration.

Pilot detector 113 comprises despreaders 113₁, 113₂ for despreading the received baseband digital signal from A/D converter 100 using a PN code and an orthogonal code, respectively; and a symbol integrator 113₃ for performing a symbol integration.

Propagation path estimator 114 estimates a propagation path based on output data from pilot detector 112.

Propagation path compensator 115 compensates output data from pilot detector 113 for a propagation path based on the result of propagation path estimation in propagation path estimator 114.

However, in the RAKE receiver illustrated in FIG. 1, since each of the receiver units equal in number to the multiplexed codes comprises a number of finger units equal to the number of fingers, the RAKE receiver requires a number of finger units equal to the number of multiplexed codes multiplied by the number of fingers.

As a result, as pointed out as well in the aforementioned patent gazette, the RAKE receiver for receiving multiplexed codes in a multipath environment has problems of a prohibitively large circuit scale, and inability to reduce the size and cost of a mobile terminal device.

### SUMMARY OF THE INVENTION

It is an object of the present invention to provide a RAKE receiver for receiving multiplexed codes in a multipath environment, which is capable of reducing the size and cost of a mobile terminal device.

The RAKE receiver of the present invention has a chip rate finger processing unit for despreading received data and performing symbol integration for the received data, and a symbol rate finger processing unit for estimating propagation paths through which the received data has passed, and compensating the received data for the propagation paths. Then, the RAKE receiver has a plurality of chip rate finger processing units corresponding to the number of fingers, and symbol rate finger processing unit for the plurality of chip rate finger processing units. The symbol rate finger processing unit compensates each of received data delivered from the plurality of chip rate finger processing units for the associated propagation paths, and then combines the received data sharing a common multiplexed code with one another for each multiplexed code.

With the foregoing configuration, the RAKE receiver can be largely reduced in circuit scale, thereby making it possible to reduce the size and cost of a mobile terminal device.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram of an exemplary conventional RAKE receiver;

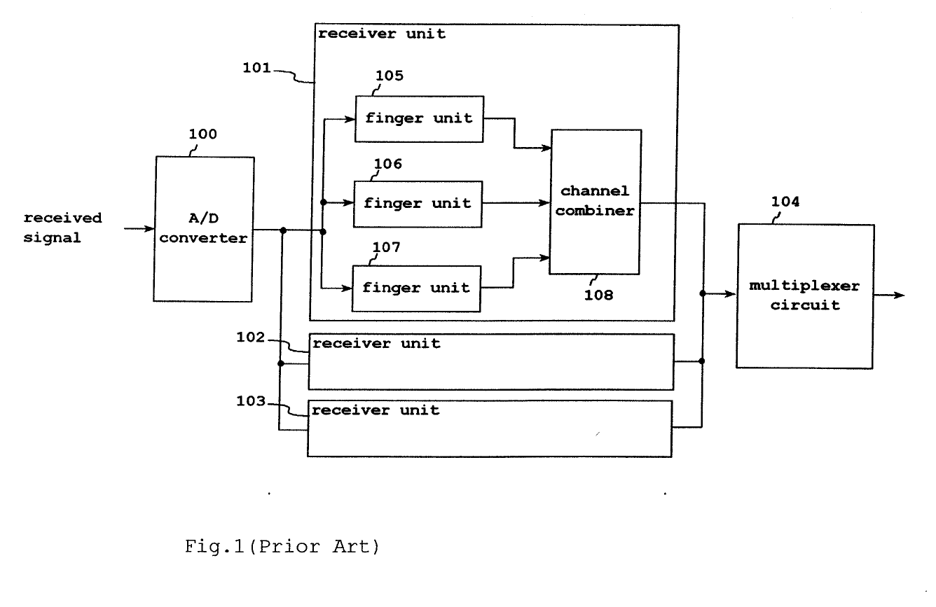

FIG. 2 is a block diagram of a finger unit shown in FIG. 1;

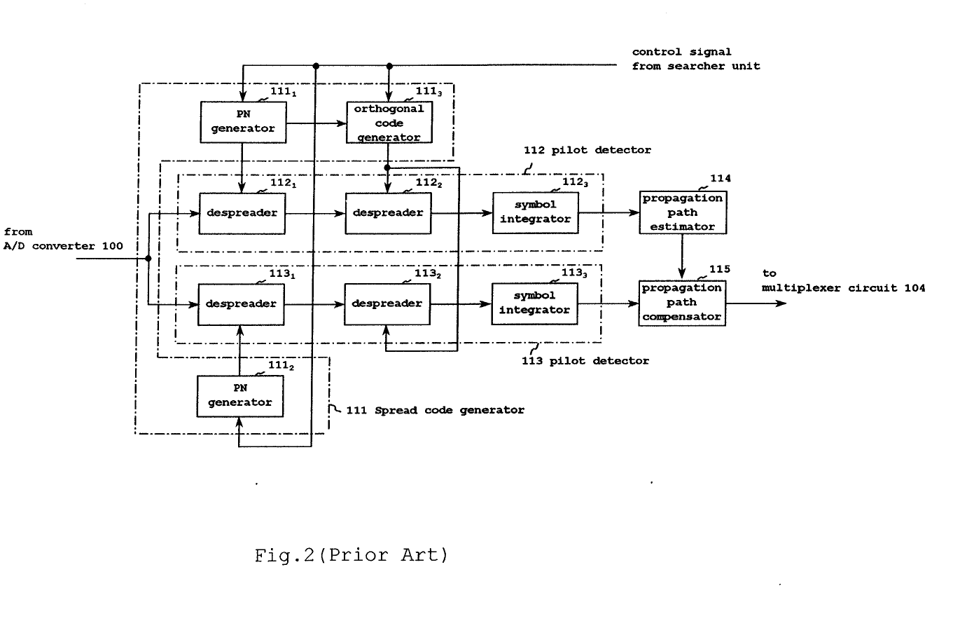

FIG. 3 is a block diagram of a RAKE receiver according to one embodiment of the present invention;

FIG. 4 is a block diagram of a chip rate finger unit shown in FIG. 3;

FIG. 5 is a block diagram of a symbol rate finger/channel combiner unit shown in FIG. 3;

FIG. 6 is a timing chart showing operating timings of the chip rate finger unit shown in FIG. 4;

FIG. 7 is a timing chart showing operating timings of the symbol rate finger/channel combiner unit shown in FIG. 5;

FIG. 8 is a diagram illustrating an exemplary configuration associated with a register shown in FIGS. 4 and 5;

FIG. 9 is a block diagram of another chip rate finger unit in the RAKE receiver according to the present invention;

FIG. 10 is a block diagram of another symbol rate finger/channel combiner unit in the RAKE receiver according to the present invention; and

FIG. 11 is a block diagram of yet another symbol rate finger/channel combiner unit in the RAKE receiver according to the present invention.

### DESCRIPTION OF THE PREFERRED EMBODIMENTS

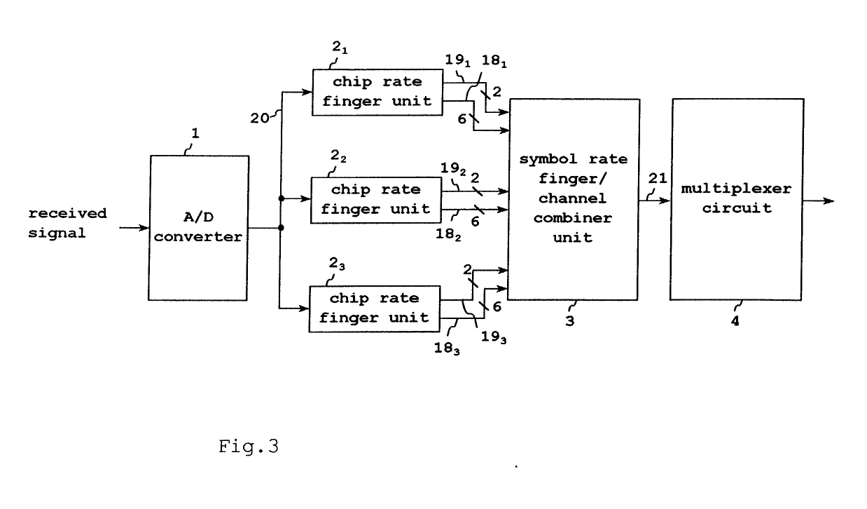

As illustrated in FIG. 3, a RAKE receiver according to one embodiment of the present invention comprises A/D converter 1; chip rate finger units 2₁-2₃; symbol rate finger/channel combiner unit 3; and a multiplexer circuit 4. As can be seen, FIG. 3 illustrates a RAKE receiver for the number of multiplexed codes equal to three and the number of fingers equal to three.

Upon receipt of a received signal including channel data, i.e., communication data, and pilot data for identifying a base station (not shown) from the base station, the RAKE receiver in this embodiment processes a total of four codes consisting of three codes (the number of multiplexed codes) to which the channel data is assigned, and one code to which the pilot data is assigned, in time division to demodulate the received signal.

The received signal supplied to A/D converter 1 is a baseband signal which is converted in a predetermined circuit (not shown), from an RF (Radio Frequency) signal transmitted from the base station and received by an antenna (not shown).

A/D converter 1 converts the supplied baseband signal to a digital signal which is supplied to three chip rate finger units 2₁-2₃ as received baseband digital signal 20.

Chip rate finger unit 2₁-2₃, which are provided corresponding to the number of fingers, each despread received baseband digital signal 20 supplied from A/D converter 1, perform symbol integration for received baseband digital signal 20, and supplies symbol rate finger/channel combiner unit 3 with channel data 18₁-18₃ and pilot data 19₁-19₃ for each multiplexed code.

Each of chip rate finger units 2₁-2₃ is assigned a different propagation path for receiving one of received signals which have arrived through a plurality of (three in this embodiment) propagation paths.

Symbol rate finger/channel combiner unit 3 estimates phase rotations of the propagation paths assigned to respective chip rate finger units 2₁-2₃ based on pilot data 19₁-19₃ delivered from respective chip rate fingers 2₁-2₃, and compensates channel data 18₁-18₃ for the propagation paths based on the propagation path estimate values.

Further, for channel data 18₁-18₃ which have been compensated for the propagation paths, symbol rate finger/channel combiner unit 3 RAKE combines channel data, which share a common multiplexed code, for each multiplexed code, and supplies multiplexer circuit 4 with RAKE combined channel data 21.

Multiplexer circuit 4 multiplexes channel data 21 supplied from symbol rate finger/channel combiner unit 3 and delivers the resulting data as demodulated data.

Next, the configuration of each chip rate finger unit 2₁-2₃ will be described in greater detail.

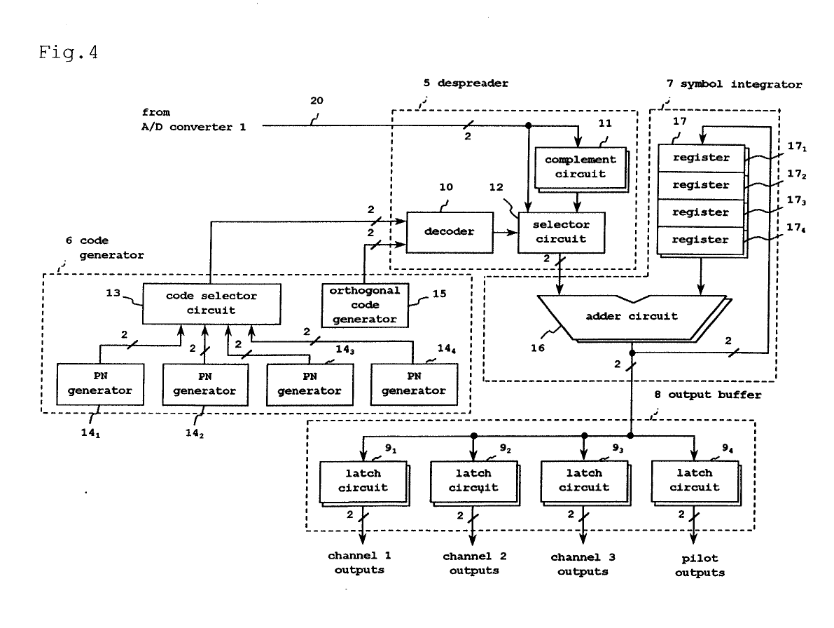

As illustrated in FIG. 4, each of chip rate finger units 2₁-2₃ comprises despreader 5, code generator 6, symbol integrator 7, and output buffer 8.

Despreader 5 comprises decoder 10, complement circuit 11, and selector circuit 12. Despreader 5 uses these components to despread received baseband digital signal 20 supplied from A/D converter 1 in time division using an orthogonal code and a PN code. The despreading in despreader 5 involves a complex multiplication of received baseband digital signal 20 by the orthogonal code and PN code. Since the PN code and orthogonal code can be generally expressed by “+1” and “−1,” despreader 5 is implemented without using a complex multiplier circuit in particular for simplifying the circuit.

Code generator 6 comprises PN generators 14₁-14₄, orthogonal code generator 15, and code selector circuit 13. PN generators 14₁-14₃ each generate a PN code (codes 1-3) for channel data. PN generator 144 generates a PN code (pilot) for pilot data. Orthogonal code generator 15 generates an orthogonal code. Code selector circuit 13 switches four PN codes generated in PN generators 14₁-14₄, and supplies despreader 5 with the PN codes in time division.

Symbol integrator 7 comprises register unit 17 comprised of four registers 171-174, equal to the number of time division, and an adder circuit 16. Symbol integrator 7 uses these components to perform symbol integration for the despread data delivered from despreader 5 in time division.

Output buffer 8 comprises four latch circuits 9₁-9₄, each of which once latches and delivers symbol data for every four codes, equal to the number of time division, delivered from symbol integrator 7. Symbol data once latched and delivered from latch circuits 9₁-9₃ are supplied to symbol rate finger/channel combiner unit 3 as channel data 18. Symbol data once latched and delivered from latch circuit 94 is supplied to symbol rate finger/channel combiner 3 as pilot data 19.

Next, the configuration of symbol rate finger/channel combiner unit 3 will be described in greater detail.

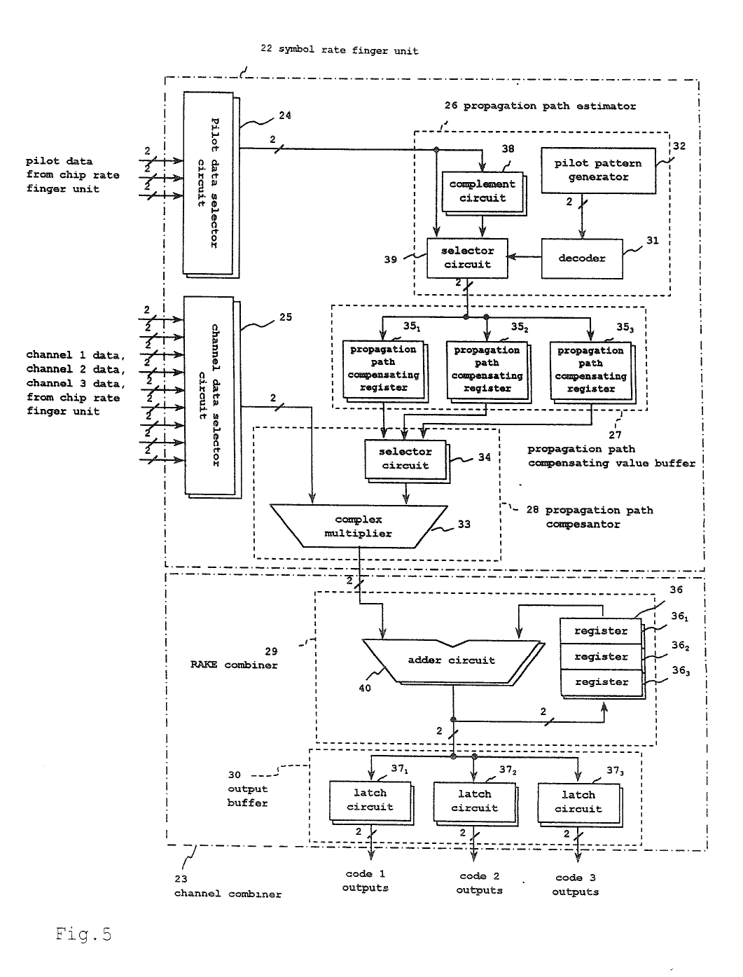

As illustrated in FIG. 5, symbol rate finger/channel combiner unit 3 comprises symbol rate finger unit 22 comprised of pilot data selector circuit 24, channel data selector circuit 25, propagation path estimator 26, propagation path compensating value buffer 27, and propagation path compesantor 28; and channel combiner unit 23 comprised of RAKE combiner 29 and output buffer 30.

Pilot data selector circuit 24 switches pilot data 19₁-19₃ supplied from respective chip rate finger units 2₁-2₃ to supply propagation path estimator 26 with pilot data 19₁-19₃ in time division.

Similarly, channel data selector circuit 25 switches channel data 18₁-18₃ supplied from respective chip rate finger units 2₁-2₃ to supply propagation path compensator 27 with channel data 18₁-18₃ in time division.

Propagation path estimator 26 comprises complement circuit 38, selector circuit 39, decoder 31, and pilot pattern generator 32. Propagation path estimator 26 uses these components to estimate, in time division, a phase rotation of a propagation path assigned to each chip rate finger unit 2₁-2₃ based on pilot data 19₁-19₃ supplied thereto through pilot data selector circuit 24. Since ideal pilot data generated in pilot pattern generator 32 can be generally expressed by “+₁” and “−1,” propagation path estimator 26 can be implemented without using a complex multiplier circuit in particular for simplifying the circuit, in a manner similar to despreader 5 in each of chip rate finger units 2₁-2₃ (see FIG. 4).

Propagation path compensating value buffer 27 comprises three propagation path compensating registers 35₁-35₃ each for storing a propagation path estimate value for each chip rate finger unit 2₁-2₃ estimated in propagation path estimator 26.

Propagation path compensator 28 comprises complex multiplier 33 and selector circuit 34. Propagation path compensator 28 uses these components to compensate channel data 18₁-18₃ supplied thereto through channel data selector circuit 25 for propagation paths in time division, based on the propagation path estimate values stored in respective propagation path compensating registers 35₁-35₃.

RAKE combiner unit 29 comprises register unit 36 comprised of three registers 36₁-36₃ equal to the number of multiplexed codes, and adder circuit 40. RAKE combiner unit 29 uses these components to RAKE combine channel data 18₁-18₃, which share a common multiplexed code and have undergone the propagation path compensation in propagation path compensator 28, in time division for each multiplexed code.

Output buffer 30 is comprised of three latch circuits 37₁-37₃ each for once latching and delivering channel data, which has been RAKE combined, for each of multiplexed codes delivered from RAKE combiner unit 29. The channel data once latched and delivered from latch circuits 37₁-37₃ is supplied to multiplexer circuit 4 as channel data 21.

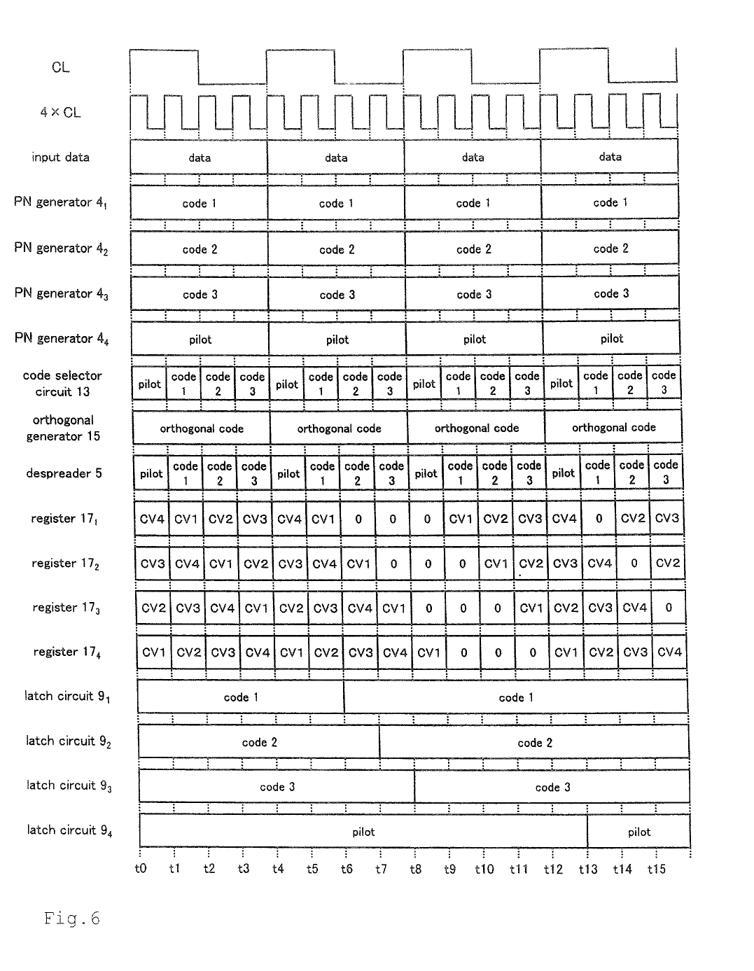

In the following, the operation of chip rate finger units 2₁-2₃ illustrated in FIG. 4 will be described with reference to a timing chart in FIG. 6.

Each of chip rage finger units 2₁-2₃ is supplied with received baseband digital signal 20 from A/D converter 1 as input data at intervals of chip rate clock (CL) (at times t0, t4, t8, . . . ).

In code generator 6, PN generators 14₁-14₃ each generate a PN code for channel data (codes 1-3), and PN generator 14₄ generates a PN code for pilot data (pilot) at intervals of chip rate clock (at times t0, t4, t8, . . . ).

In this embodiment, four codes are processed in time division. Therefore, code selector circuit 13 sequentially switches the PN codes generated in PN generators 14₁-14₄ for selection at a clock cycle four time the chip rate clock (at times t0, t1, t2, . . . ), and supplies despreader 5 with sequentially selected PN codes.

Orthogonal code generator 15 generates an orthogonal code at a cycle of chip rate clock (at times t0, t4, t8, . . . ), and supplies despreader 5 with the orthogonal code.

In despreader 5, at a clock cycle four times the chip rate clock (at times t0, t1, t2, . . . ), decoder 10 decodes the orthogonal code and PN code respectively supplied from orthogonal code generator 15 and code selector circuit 13, and selector circuit 12 despreads received baseband digital signal 20 supplied from A/D converter 1 using the orthogonal code and PN code decoded by decoder 10, and sequentially delivers the result of despreading.

It should be noted that the data “-1” within received baseband digital signal 20 delivered from A/D converter 1 is supplied to selector circuit 12 after its complement is taken in complement circuit 11.

In symbol integrator 7, adder circuit 16 adds the despread data sequentially delivered from despreader 5 and data stored in register 174 at a clock cycle four times the chip rate clock (at times t0, t1, t2, . . . ) and stores the result of addition in register 171 as a correlation value.

For example, adder circuit 16 adds pilot data (pilot) at time t0, and stores a correlation value (CV1), which is the result of addition, in register 17₁. Similarly, adder circuit 16 adds channel data (code 1) at time t1, and stores a correlation value (CV2), which is the result of addition, in register 171. Also, adder circuit 16 adds channel data (code 2) at time t2, and stores a correlation value (CV3), which is the result of addition, in register 171. Further, adder circuit 16 adds channel data (code 3) at time t3, and stores a correlation value (CV4), which is the result of addition in register 171.

Here, register unit 17 is implemented as a shift register unit which is comprised of four registers 17₁-17₄. In this embodiment, since four codes are processed in time division, register unit 17 shifts the stored data at a clock cycle four times the chip rate clock. For this reason, despread data for four codes delivered from despreader 5 are accumulatively added at the cycle of chip rate clock for each code.

Further, when adder circuit 16 adds channel data (code 1) at time t5 and as a result, completes the previously determined number of times of accumulative additions for this channel data (code 1), adder circuit 16 delivers this accumulative addition data as symbol data for code 1 at time t6. Similarly, adder circuit 16 delivers accumulative addition data for channel data (code 2) as symbol data for code 2 at time t7; delivers accumulative addition data for channel data (code 3) as symbol data for code 3 at time t8; and delivers accumulative addition data for the pilot data (pilot) as symbol data for the pilot code at time tl3. In this event, the symbol integration is continuously performed for the next symbol data by writing “0” into register 171.

Subsequently, each of symbol data for each code delivered from symbol integrator 7 is stored in each of latch circuits 9₁-9₄ in output buffer 8, and once latched in and delivered from each of latch circuits 9₁9₄.

Output data from respective latch circuit 9₁-9₄ is supplied to symbol rate finger/channel combiner unit 3 as channel data 18₁-18₃ or pilot data 19₁-19₃.

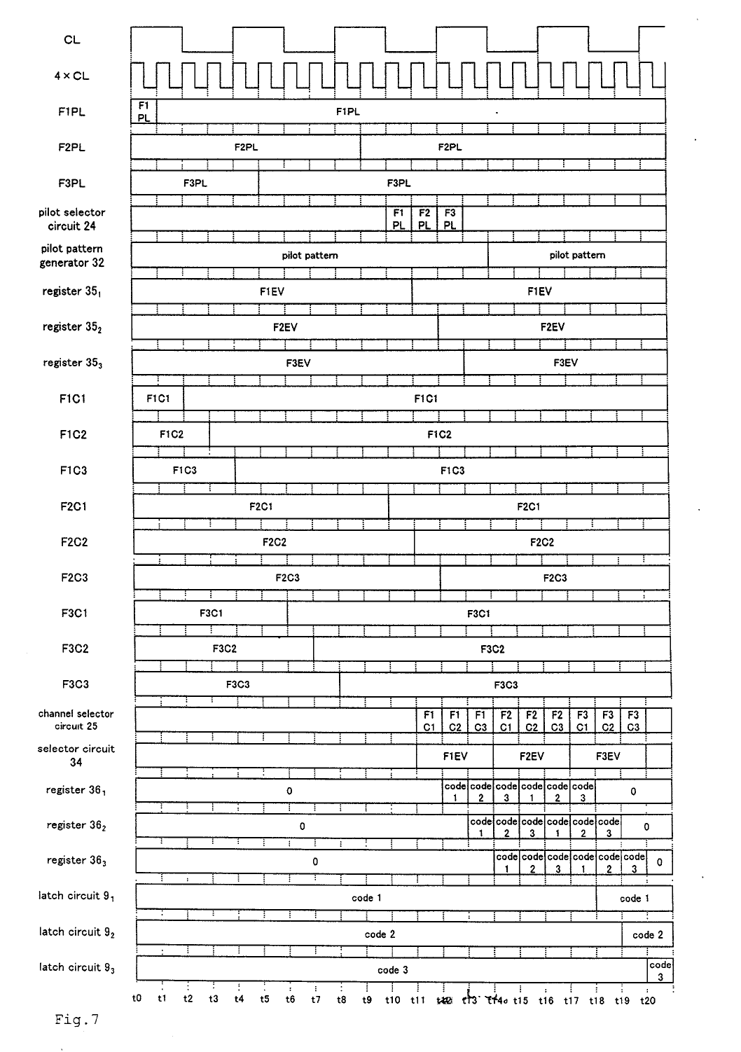

Next, the operation of symbol rate finger/channel combiner unit 3 illustrated in FIG. 5 will be described with reference to a timing chart in FIG. 7.

In this embodiment, each of chip rate finger units 2₁-2₃ is provided for receiving each of signals which have arrived through three different propagation paths, as described above, so that chip rate finger units 2₁-2₃ differ from one another in operation timing. Therefore, the description in connection with FIG. 7 will be made on the assumption that data from respective chip rate finger units 2₁-2₃ also arrive at different input timings from one another. Specifically, a received signal passing a propagation path assigned to chip rate finger unit 2₁ arrives earliest; a received signal passing a propagation path assigned to chip rate finger unit 2₃ arrives one chip rate clock later than the earliest arrival; and a received signal passing a propagation path assigned to chip rate finger unit 2₂ arrives another one chip rate clock later. Operation timings for each of chip rate finger units 2₁-2₃ are notified from a functional block called a “searcher unit,” not shown, in a manner similar to a general RAKE receiver.

Also, symbol rate finger/channel combiner unit 3 starts the operation on the basis of the input timing of data from the chip rate finger unit, out of chip rate finger units 2₁-2₃, which is assigned the propagation path through which a received signal arrives latest. Therefore, the description in connection with FIG. 7 will be made on the assumption that symbol rate finger/channel combiner unit 3 starts the operation on the basis of the input timing of the data from chip rate finger unit 2₂.

Symbol rate finger/channel combiner unit 3 processes data from respective chip rate finger units 2₁-2₃ in an arbitrary order. In FIG. 7, the description will be made on the assumption that symbol rate finger/channel combiner unit 3 starts the processing on the data from chip rate finger unit 21 which is assigned the propagation path through which a received signal arrives earliest.

Pilot data selector circuit 24 first selects pilot data (F1PL) from chip rate finger unit 2₁ at time t10 on the basis of the input timing (at time t9) of pilot data (F2PL) from chip rate finger unit 2₂, and supplies the selected pilot data to propagation path estimator 26.

In propagation path estimator 26, selector circuit 39 complex multiplies the pilot data (F1PL) delivered from pilot data selector circuit 24 by ideal pilot data generated in pilot pattern generator 32 and decoded in decoder 31 for comparison, thereby estimating a phase rotation of the propagation path assigned to chip rate finger unit 2₁. An estimate value (F1EV) for chip rate finger unit 2₁ is stored in propagation path compensating register 35₁ at time t11.

It should be noted that data “−1” within pilot data delivered from pilot data selector circuit 24 is supplied to selector circuit 39 after its complement is taken in complement circuit 38.

Propagation path estimator 26 repeats the foregoing processing the number of times equal to the number of fingers (three times in this embodiment) to estimate phase rotations for the propagation paths assigned to respective chip rate finger units 2₁-2₃, and stores these results of estimation in propagation path compensating registers 35₁-35₃, respectively. Specifically, an estimate value (F2EV) for chip rate finger unit 2₂ is stored in propagation path compensating register 35₂ at time t12, while an estimate value (F3EV) for chip rate finger unit 2₃ is stored in propagation path compensating register 35₃ at time t13. The foregoing processing completes the propagation path estimation.

Channel data selector circuit 25 first selects channel data (F1C1) for code 1 from chip rate finger unit 2₁ at time t11 on the basis of the input timing (at time t10) of the first channel data (F2C1) from chip rate finger unit 2₂, and supplies propagation path compensator 28 with the selected channel data.

In this event, in propagation path compensator 28, selector circuit 34 selects a propagation path compensating value (F1EV) for chip rate finger unit 2₁ stored in propagation path compensating register 35₁, and supplies complex multiplier 33 with the selected propagation path compensating value so as to correspond to channel data (F1C1) delivered from channel data selector circuit 25. Complex multiplier 33 in turn complex multiplies channel data (F1C1) for code 1 delivered from channel data selector circuit 25 by the propagation path compensating value (F1EV) for chip rate finger unit 2₁ delivered from selector circuit 34 to compensate the channel data (F1C1) for the propagation path, and supplies RAKE combiner unit 29 with the channel data compensated for the propagation path.

Subsequently, channel data selector circuit 25 sequentially selects and delivers channel data (F1C2, F1C3) for code 2 and code 3 from chip rate finger unit 21 at times t12, t13. As all channel data from chip rate finger unit 2₁ has delivered, channel data selector circuit 25 sequentially selects and delivers channel data (F2C1, F2C2, F2C3) for code 1-code 3 from chip rate finger unit 22 at times t14, t15, t16. As all channel data from chip rate finger unit 22 has delivered, channel data selector circuit 25 sequentially selects and delivers channel data (F3C1, F3C2, F3C3) for code 1-code 3 from chip rate finger unit 2₃ at times t17, t18, t19. Selector circuit 34 selects and delivers propagation path compensated values corresponding to channel data sequentially delivered from channel data selector circuit 25 from among propagation path compensated values (F1EV F3EV) stored in respective propagation path compensating registers 35₁-35₃ at times t12-t19. Complex multiplier 33 complex multiplies channel data sequentially delivered from channel data selector circuit 25 by propagation path compensated values delivered from selector circuit 34 to compensate the channel data for propagation paths, and sequentially delivers the channel data compensated for associated propagation paths.

With the foregoing processing, propagation path compensator 28 sequentially supplies RAKE combiner unit 29 with the channel data compensated for the associated propagation paths.

In RAKE combiner unit 29, adder circuit 40 adds the channel data sequentially delivered from propagation path compensator 28 and data stored in register 363, and stores the result of this addition in register 361. Register unit 36 is implemented as a shift register unit comprised of three registers 36₁-36₃. Three registers 36₁-36₃ shift stored data at a clock cycle four times the chip rate clock.

RAKE combiner unit 29 repeats the foregoing processing the number of times equal to the number of fingers (three times in this embodiment) to RAKE combine channel data, which share multiplexed codes, with one another for each multiplexed code, and delivers the RAKE combined channel data.

For example, RAKE combiner unit 29 RAKE combines channel data (F1C1, F2C1, F3C1) for code 1 at times t11, t14, t17, and delivers the resulting data at time t18. Similarly, RAKE combiner unit 29 RAKE combines channel data (F1C2, F2C2, F3C2) for code 2 at times t12, t15, t18, and delivers the resulting data at time t19. Also, RAKE combiner unit 29 RAKE combines channel data (F1C3, F2C3, F3C3) for code 3 at times t13, t16, t19, and delivers the resulting data at time t20.

Subsequently, the channel data delivered from RAKE combiner unit 29 is stored in each of latch circuits 37₁-37₃ in output buffer 30, and once latched and delivered from latch circuits 37₁-37₃.

Output data from each latch circuit 37₁-37₃ is supplied to multiplexer circuit 4 as channel data 21.

In this embodiment, register unit 17 in symbol integrator 7 shown in FIG. 4, and shift register unit 36 in RAKE combiner 29 shown in FIG. 5 are implemented as shift register units which however have a problem of large current consumption.

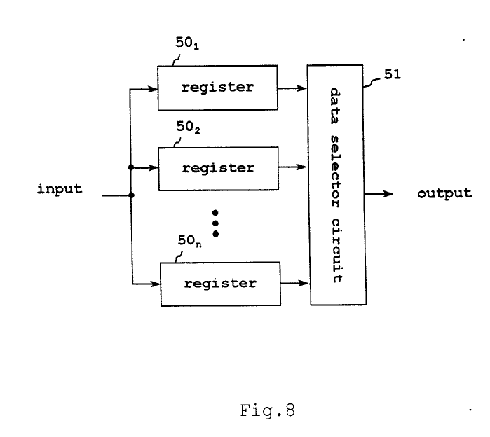

To solve this problem, the aforementioned register units 17, 36 are configured, for example, as illustrated in FIG. 8, where data selector circuit 51 is disposed at the back of registers 50₁-50ₙ. In this register configuration, when data is supplied, data is loaded into a necessary register at a necessary time, and when data is delivered, data selector circuit 51 selects data for delivery. The current consumption can be reduced by the modification to the register configuration as described.

Alternatively, a data selector circuit may be additionally disposed in front of registers 50₁-50ₙ, such that the previous data selector circuit selects input data and loads it into required registers 50₁-50ₙ, or a clock circuit may be connected to each of registers 50₁50ₙ, such that registers 50₁-50ₙ operate in response to a clock from the clock circuit to load data thereinto when necessary.

While the foregoing embodiment has been described on the assumption that the channel data for code 1-code 3 have the same symbol rate (a cycle at which the symbol integration is performed), the symbol rates need not be the same in particular for the respective codes. When the respective codes are different in symbol rate from one another, the different symbol rates can be supported by changing a timing at which symbol data is erased from register unit 17 in symbol integrator 7 of each chip rate finger unit 2₁-2₃, and a timing at which symbol data is delivered. Simultaneously, in channel combiner 23 of chip rate finger/channel combiner unit 3, the output timing of RAKE combiner unit 29 may only be modified, such that it operates to supply data to output buffer 30 on the bases of a timing of the code having the highest symbol rate (the shortest cycle at which the symbol integration is performed).

Also, while the foregoing embodiment has been described for an example in which three multiplexed codes are used, the present invention can accommodate a larger number of multiplexed codes. For this purpose, each of chip rate finger units 2₁-2₃ is additionally provided with a number of PN generators in code generator 6 and a number of registers in symbol integrator 7 equal to the number of increased codes, and employs a clock, the rate of which is higher than the clock four times the chip rate clock. Further, symbol rate finger/channel combiner unit 3 is additionally provided with a number of registers in RAKE combiner 29 and a number of latch circuits in output buffer 30 equal to the number of increased codes, and employs a clock, the rate of which is higher than the clock four times the chip rate clock.

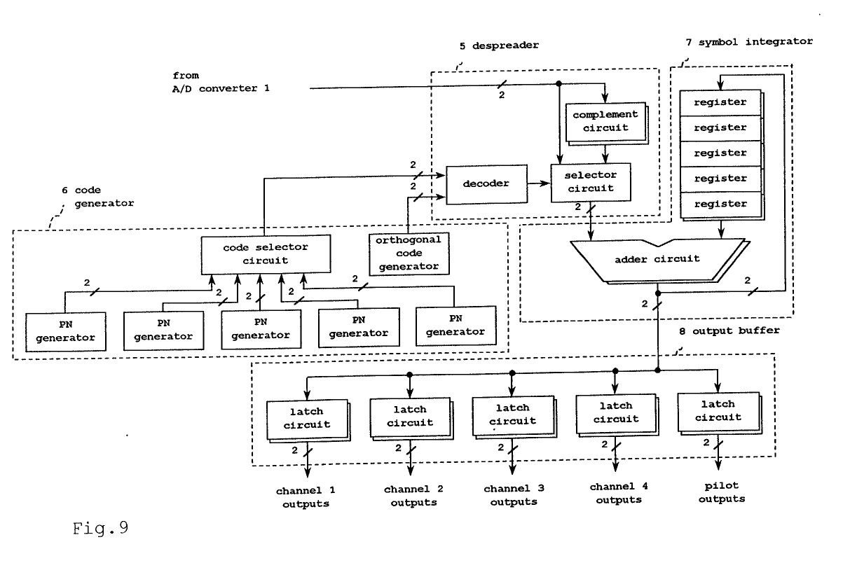

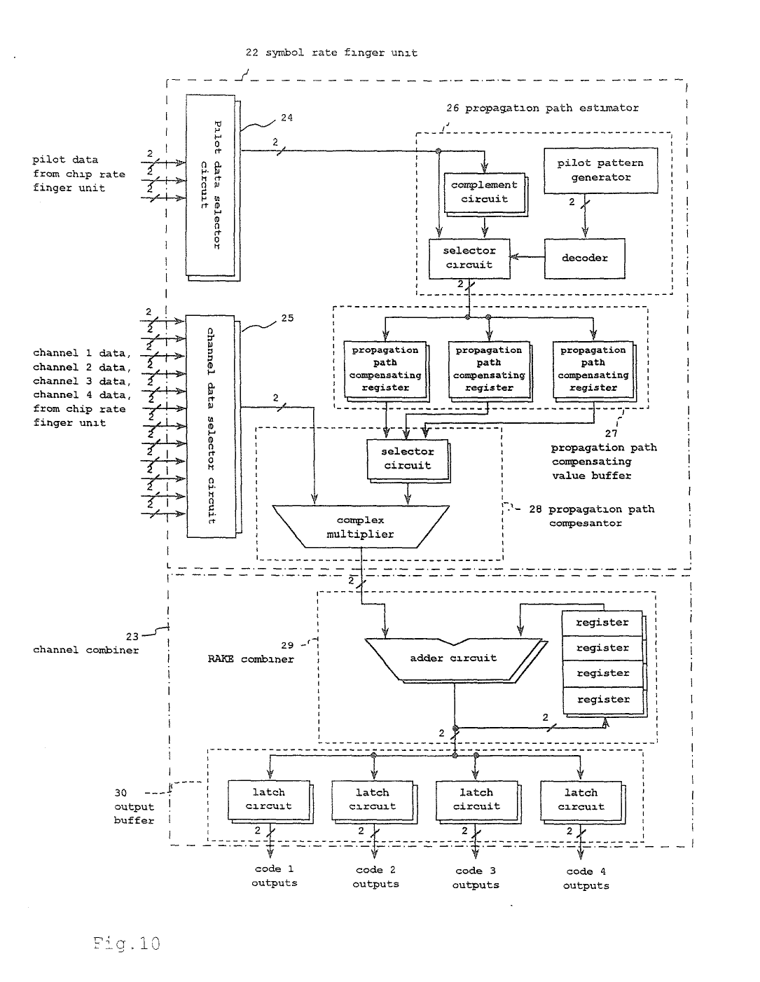

For example, FIG. 9 illustrates an exemplary circuit of the chip rate finger unit and FIG. 10 illustrates an exemplary circuit of the symbol rate finger/channel combiner unit when four codes are multiplexed, and a total of five codes are processed in time division, including four multiplexed codes for channel data and one code for pilot data. Assume in FIGS. 9 and 10 that there are three fingers, as is the case with FIGS. 4 and 5.

The chip rate finger unit illustrated in FIG. 9 differs from the chip rate finger unit illustrated in FIG. 4 in that it comprises five PN generators in code generator 6 and five registers in symbol integrator 7 instead of four, and employs a clock, the rate of which is five times faster than the chip rate clock.

The symbol rate finger/channel combiner unit illustrated in FIG. 10 differs from the symbol rate finger/channel combiner unit illustrated in FIG. 5 in that it comprises four registers in RAKE combiner unit 29 and four latch circuits in output buffer 30 instead of three, and employs a clock, the rate of which is five times higher than the chip rate clock.

Also, while the foregoing embodiment has been described for an example in which there are three fingers, and three chip rate finger units 2₁-2₃ are provided, the number of fingers may be increased, in which case the RAKE receiver is provided with a number of chip rate finger units equal to the number of increased fingers.

In this event, the symbol rate finger/channel combiner unit has an increased number of inputs to pilot data selector circuit 24 and to channel data selector circuit 25. To address this increase in the number of inputs, it is essential only that propagation path estimator 26 estimates propagation paths for the number of fingers, and that propagation path compensator 28 compensates for the propagation paths for the number of fingers. As a corresponding addition of circuit components, propagation path compensating value buffer 27 is only provided with a number of propagation path compensating registers equal to the number of increased fingers.

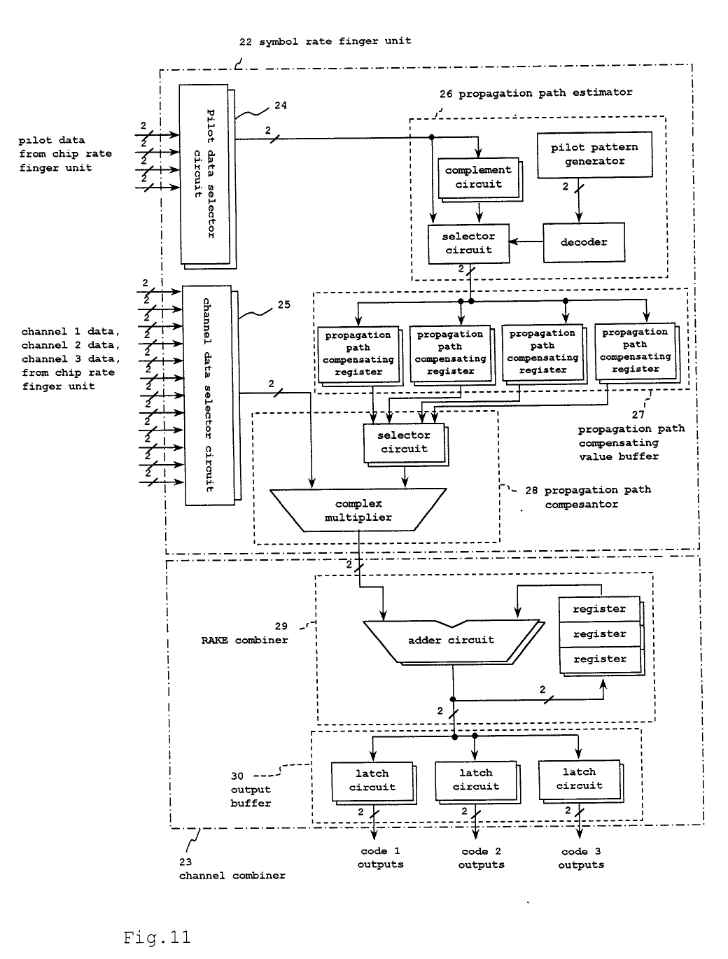

For example, FIG. 11 illustrates an exemplary circuit of symbol rate finger/channel combiner unit when the RAKE receiver comprises four fingers and four chip rate finger units instead of three. Assume in FIG. 11 that three codes are multiplexed, as is the case with FIG. 5.

The symbol rate finger/channel combiner unit illustrated in FIG. 11 differs from the symbol rate finger/channel combiner unit illustrated in FIG. 5 in that it comprises four propagation path compensating registers in propagation path compensating value buffer 27, instead of three, and propagation path estimator 26 estimates propagation paths for four fingers, and propagation path compensator 28 compensates for propagation paths for four fingers.

While preferred embodiments of the present invention have been described using specific terms, such description is for illustrative purposes only, and it is to be understood that changes and variations may be made without departing from the spirit or scope of the following claims.

What is claimed is:

1. A RAKE receiver comprising:
chip rate finger processing means including code generator means for generating a code for received data, despreading means for despreading said received data using the code generated by said code generating means, and symbol integrating means for performing symbol integration for said received data despread by said despreading means; and
symbol rate finger processing means including propagation path estimating means for estimating propagation paths through which said received data has passed, and propagation path compensating means for compensating said received data, subjected to the symbol integration in said symbol integrating means, for the propagation paths based on the result of propagation path estimation in said propagation path estimating means.

2. The RAKE receiver according to claim 1, wherein said RAKE receiver comprises a plurality of said chip rate finger processing means corresponding to the number of fingers, said symbol rate finger processing means being allocated to said plurality of chip rate finger processing means.

3. The RAKE receiver according to claim 2, wherein said symbol rate finger processing means further includes data selecting means for supplying said propagation path estimating means in time division with the received data, subjected to the symbol integration in said symbol integrating means in said chip rate finger processing means,
said propagation path estimating means includes means for estimating said propagation paths in time division, and
said propagation path compensating means includes means for compensating said received data for the propagation paths in time division.

4. The RAKE receiver according to claim 3, wherein:
said code generating means includes code selecting means for supplying said codes to said despreader means in time division,
said despreading means includes means for despreading said received data in time division, and
said symbol integrating means includes means for performing the symbol integration for said received data in time division.

5. The RAKE receiver according to claim 4, wherein said symbol integrating means includes:
a number of registers equal to the number of time division; and
adding means for accumulatively adding in time division the received data despread in said despreading means and data stored in said registers, and storing the results of addition in said registers as symbol integration values of said received data.

6. The RAKE receiver according to claim 5, wherein said symbol rate finger processing means further includes channel combining means for RAKE combining in time division the received data which are compensated for the propagation paths in said propagation path compensating means and share a common multiplexed code, for each multiplexed code.

7. The RAKE receiver according to claim 6, further comprising multiplexing means disposed at the back of said symbol rate finger processing means for multiplexing the received data RAKE combined for each multiplexed code in said channel combining means, and delivering the multiplexed received data as demodulated data.
